(19) United States
(12) Patent Application Publication
(10) Pub. No.: US 2008/0143647 A1
(43) Pub. Date: Jun. 19, 2008

(54) PLASMA DISPLAY DEVICE AND DRIVING METHOD THEREOF

(76) Inventor: Tae-Hyun Kim, Suwon-si (KR)

Correspondence Address: CHRISTIE, PARKER & HALE, LLP, PO BOX 7068, PASADENA, CA, 91109-7068, US

(21) Appl. No.: 11/955,210

(22) Filed: Dec. 12, 2007

(30) Foreign Application Priority Data
Dec. 18, 2006 (KR) 10-2006-0129409

(51) Int. Cl. G09G 3/28

(52) U.S. Cl. 345/67

(57) ABSTRACT

In one embodiment, a method for driving a plasma display device during an address period is provided. The plasma display device includes a plasma display panel (PDP) having different electrode arrangement configurations between discharge cells of the PDP neighboring in a column direction. The PDP includes the discharge cells formed at crossing regions of first, second, and third electrodes, and barrier ribs, each of the discharge cells being individually surrounded by the barrier ribs. The PDP has an alignment error between the first and second electrodes and the barrier ribs. The method includes: applying a first sustain pulse having a high level duration period longer than a first period to the first electrodes; and applying a second sustain pulse having a high level duration period shorter than the first period to the second electrodes. The first and second sustain pulses alternately have high and low levels, and have opposite phases.

### CROSS-REFERENCE TO RELATED APPLICATION

This application claims priority to and the benefit of Korean Patent Application No. 10-2006-0129409 filed in the Korean Intellectual Property Office on Dec. 18, 2006, the entire content of which is incorporated herein by reference.

### BACKGROUND OF THE INVENTION

1. Field of the Invention

The present invention relates to a plasma display device and a driving method thereof.

2. Description of the Related Art

A plasma display device is a display device employing a plasma display panel (PDP) configured to display characters and/or images using plasma generated by gas discharge, and the plasma display device has higher luminance (or brightness) and luminous efficiency and a wider viewing angle compared to other display devices. Accordingly, the plasma display device is being touted as a substitute for conventional cathode ray tubes (CRTs) for large-screen displays of more than 40 inches.

Generally, a plasma display panel (PDP) of the plasma display device includes a plurality of address electrodes (hereinafter referred to as “A electrodes”) extending in a column direction, and a plurality of sustain and scan electrodes (hereinafter respectively referred to as “X electrodes” and “Y electrodes”) in pairs extending in a row direction. The A electrodes cross the X and Y electrodes. A configuration in which the X electrodes and Y electrodes are sequentially arranged in a column direction is referred to as an “XYXY arrangement configuration”. Here, a space defined by the A, X, and Y electrodes forms a discharge cell.

A resolution of the plasma display device is determined according to the number of discharge cells formed in the PDP, and the PDP is now being developed to increase the resolution (i.e., to realize high-definition).

To achieve the high-definition, it may be required to reduce the size of discharge cells formed in the PDP to increase the number of discharge cells. However, the total capacitance increases as the number of discharge cells increases, and the discharge efficiency decreases as the size of discharge cells decreases.

Accordingly, an XY arrangement configuration formed by varying the XYXY configuration in a high-definition PDP has been developed and used to solve the problem of the increased capacitance, and a phosphor coating area is increased by using a closed barrier rib configuration of the discharge cells to compensate for the decreased discharge efficiency. In the closed barrier rib configuration, neighboring discharge cells are partitioned by barrier ribs, and in further detail, discharge cells are individually surrounded by the barrier ribs.

However, in the PDP having the closed barrier rib configuration (hereinafter referred to as a “closed barrier rib configuration”) and different electrode configurations between the neighboring discharge cells (i.e., arrangement configurations of the X and Y electrodes) in the above-described XY arrangement configuration, image streaking may be generated between even and odd lines when an alignment error occurs between the X and Y electrodes. The term “image streaking” refers to a luminance difference between neighboring discharge cells when the same driving waveform is applied.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Aspects of exemplary embodiments according to the present invention are directed to providing a plasma display device for reducing image streaking in a plasma display panel (PDP) wherein the image streaking between even and odd lines is caused by an alignment error, and a driving method thereof.

In one embodiment, a method for driving a plasma display device during an address period of a subfield is provided. The plasma display device includes a plasma display panel (PDP) having different electrode arrangement configurations between discharge cells of the PDP neighboring in a column direction. The PDP includes a plurality of first electrodes and a plurality of second electrodes, a plurality of third electrodes crossing the first and second electrodes, the discharge cells formed at crossing regions of the first, second, and third electrodes, and a plurality of barrier ribs, each of the discharge cells being individually surrounded by the barrier ribs. The PDP has an alignment error between the first and second electrodes and the barrier ribs. The method includes: applying a first sustain pulse having a high level duration period longer than a first period to the first electrodes; and applying a second sustain pulse having a high level duration period shorter than the first period to the second electrodes. The first and second sustain pulses alternately have a high level and a low level, and the first and second sustain pulses have opposite phases with respect to each other.

In another embodiment, a plasma display device adapted to be driven during frames is provided. The plasma display device includes: a plasma display panel (PDP) having different electrode arrangement configurations between discharge cells of the PDP neighboring in a column direction, the PDP including a plurality of first electrodes and a plurality of second electrodes, a plurality of third electrodes crossing the first and second electrodes, the discharge cells formed at crossing regions of the first, second, and third electrodes, and a plurality of barrier ribs, each of the discharge cells being individually surrounded by the barrier ribs. The plasma display panel further includes: a controller for dividing each of the frames into a plurality of subfields, each of the subfields including a reset period, an address period, and a sustain period, and for driving the subfields; a first electrode driver for generating a first sustain pulse according to a control operation of the controller and applying the first sustain pulse to the plurality of first electrodes; and a second electrode driver for generating a second sustain pulse according to the control operation of the controller and applying the second sustain pulse to the plurality of second electrodes. The first sustain pulse has a high level duration period longer than a first period and the second sustain pulse has a high level duration period shorter than the first period. The first and second electrode drivers are adapted to alternately apply the first and second sustain pulses to the first and second electrodes, respectively, the first and second sustain pulses having opposite phases with respect to each other.

### BRIEF DESCRIPTION OF THE DRAWINGS

FIG. 1 shows a diagram of a plasma display device according to an exemplary embodiment of the present invention.

FIG. 2 shows a diagram of a configuration of a plasma display panel (PDP) according to one exemplary embodiment of the present invention.

FIG. 3 shows a diagram of a configuration of a PDP according to another exemplary embodiment of the present invention.

FIG. 4 shows a diagram of a closed barrier rib configuration of a PDP according to a first exemplary embodiment of the present invention.

FIG. 5 shows a diagram of a closed barrier rib configuration of a PDP according to a second exemplary embodiment of the present invention.

FIG. 6 shows a diagram of a closed barrier rib configuration of a PDP according to a third exemplary embodiment of the present invention.

FIG. 7 shows a diagram representing areas of sustain and scan electrodes of a PDP having no alignment error.

FIG. 8 shows a diagram representing areas of sustain and scan electrodes in a PDP having an alignment error between the sustain and scan electrodes.

FIGS. 9A and 9B show an electrode configuration diagram of two neighboring discharge cells in a PDP having an alignment error between the sustain and scan electrodes.

FIG. 10 shows driving waveforms applied to scan and sustain electrodes during a sustain period in accordance with a driving method for a plasma display device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

A plasma display device according to an exemplary embodiment of the present invention and a driving method thereof will be described with reference to the figures.

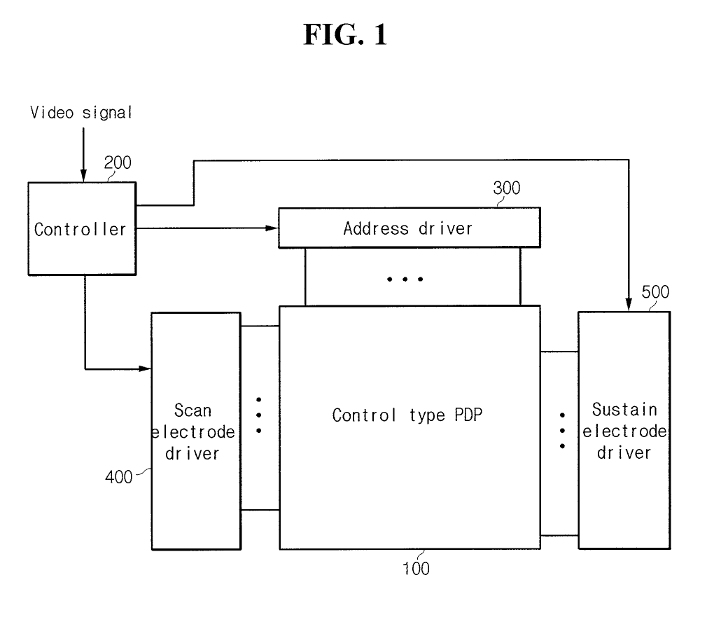

FIG. 1 shows a diagram of a plasma display device according to an exemplary embodiment of the present invention. As shown in FIG. 1, the plasma display device includes a plasma display panel (PDP) 100, a controller 200, an address driver 300, a scan electrode driver 400, and a sustain electrode driver 500.

The PDP 100 includes a plurality of A electrodes (i.e., address electrodes) extending in a column direction and a plurality of X and Y electrodes (i.e., sustain and scan electrodes) extending in a row direction. The X electrodes are formed in respective correspondence to the Y electrodes, and the X electrodes are coupled in common at one end. A discharge space at a crossing region of the A electrode and the X and Y electrodes forms a discharge cell, a barrier rib is provided between neighboring discharge cells, and the neighboring discharge cells have different electrode configurations. Respective electrode arrangement configurations of the PDP and a configuration of the discharge cells will be described later in the specification.

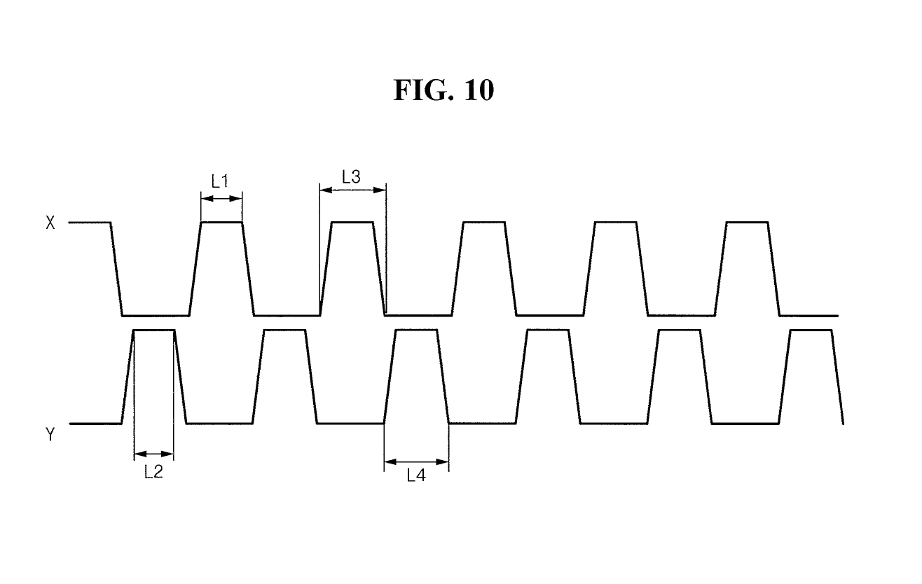

The plasma display device is driven during frames. The controller 200 divides each frame into a plurality of subfields respectively having brightness weights to express gray levels of a grayscale. Accordingly, the controller 200 receives external video signals, and outputs an address driving control signal, a sustain electrode driving control signal, and a scan electrode driving control signal. Here, the controller 200 outputs the sustain and scan electrode driving control signals, for controlling an X electrode driving waveform and an Y electrode driving waveform applied during a sustain period, as established normal waveforms when there is no alignment error in an arrangement of the X and Y electrodes of the PDP 100. However, when there is an error in the arrangement of the X and Y electrodes of the PDP 100, the controller 200 outputs the sustain and scan electrode driving signals, for controlling the X and Y electrode driving waveforms applied during the sustain period, as error compensated driving waveforms (see, for example, FIG. 10) formed by changing the established normal waveforms.

After receiving the address driving control signal from the controller 200, the address driver 300 applies a display data signal to the A electrodes for selecting discharge cells to be displayed.

The scan electrode driver 400 generates a driving waveform according to the scan electrode driving control signal received from the controller 200, and applies the driving waveform to the Y electrodes. Here, when receiving the scan electrode driving control signal from the controller 200 for compensating the image streaking, the scan electrode driver 400 outputs the Y electrode driving waveform (see, for example, FIG. 10).

The sustain electrode driver 500 generates a driving waveform according to the sustain electrode driving control signal received from the controller 200, and applies the driving waveform to the X electrodes. Here, when receiving the sustain electrode driving control signal from the controller, the sustain electrode driver 500 outputs the X electrode driving signal (see, for example, FIG. 10).

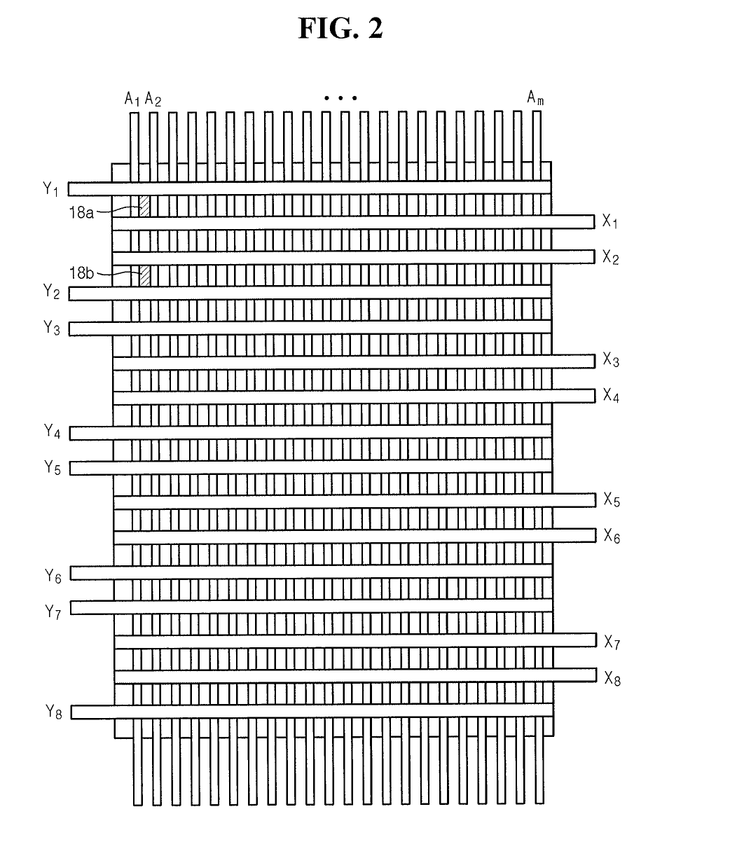

A PDP of a plasma display device according to exemplary embodiments of the present invention will be described with reference to FIG. 2 to FIG. 6.

As described above, the PDP has different electrode arrangement configurations between the neighboring discharge cells, and the barrier ribs corresponding to the discharge cells have a closed barrier rib configuration.

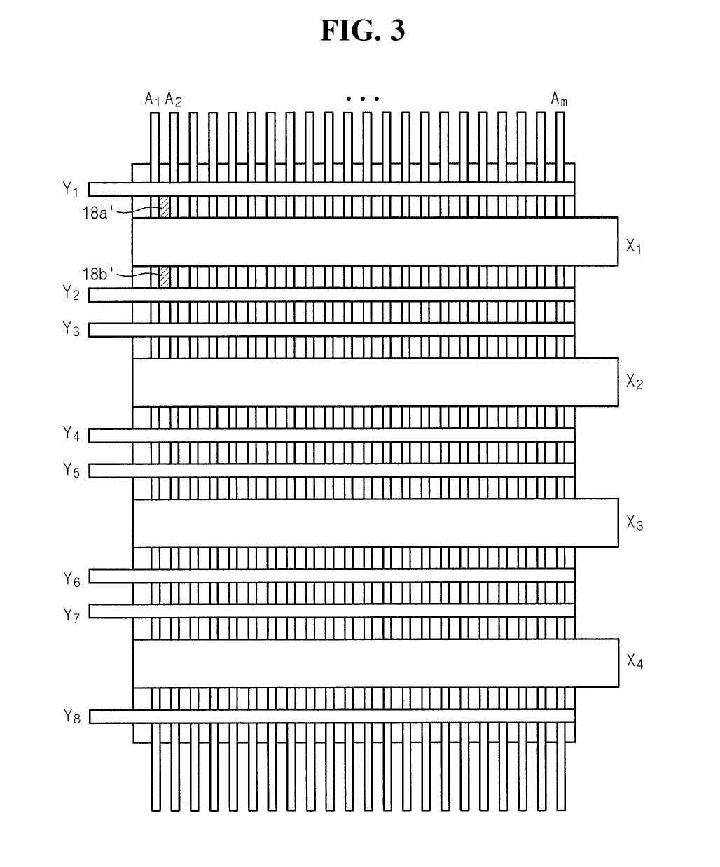

Different electrode arrangement configurations will be described with reference to FIG. 2 and FIG. 3.

FIG. 2 shows a diagram of a configuration of a PDP according to one exemplary embodiment of the present invention. The PDP shown in FIG. 2 includes a plurality of address electrodes A1, A2, . . . , and Am extending in a column direction. Pairs of X electrodes and pairs of Y electrodes are alternately arranged between the Y electrodes Y1 and Y8 formed on the panel. Generally, an arrangement configuration of the X and Y electrodes shown in FIG. 2 is referred to as an “XXYY arrangement configuration”.

In the XXYY arrangement configuration, each discharge cell 18 is formed at a crossing region of a Y electrode, an X electrode, and an A electrode.

In FIG. 2, two neighboring discharge cells 18 are denoted by reference numerals for description purposes (i.e., to compare configurations of the neighboring discharge cells). The Y electrode Y₁ is provided on the upper side of an upper discharge cell 18a, and the X electrode X₁ is provided on the lower side of the upper discharge cell 18a. Further, the X electrode X₂ is provided on the upper side of a lower discharge cell 18b, and the Y electrode Y₂ is provided on the lower side of the lower discharge cell 18b. That is, the two neighboring cells 18a, 18b may have different configurations.

Another example of neighboring discharge cell configurations will be described with reference to FIG. 3. FIG. 3 shows a diagram of a configuration of a PDP according to another exemplary embodiment of the present invention. The PDP shown in FIG. 3 includes the plurality of address electrodes A1, A2, . . . , and Am in a column direction. One X electrode and a pair of Y electrodes are alternately arranged between the Y electrodes Y1 and Y8 formed on the panel. Generally, an arrangement configuration of the X and Y electrodes shown in FIG. 3 is referred to as an “XYY arrangement configuration”.

In this electrode arrangement configuration, each discharge cell 18 is formed at a crossing region of a Y electrode, an X electrode, and an A electrode.

In FIG. 3, two neighboring discharge cells 18 are denoted by reference numeral for description purposes (i.e., to compare configurations of the neighboring discharge cells). The Y electrode is Y1 provided on the upper side of an upper discharge cell 18a′, and the X electrode X1 is provided on the lower side of the upper discharge cell 18a′. Further, the X electrode X1 is provided on the upper side of a lower discharge cell 18b′, and the Y electrode Y2 is provided on the lower side of the lower discharge cell 18b′. That is, the two neighboring cells may have different electrode arrangement configurations.

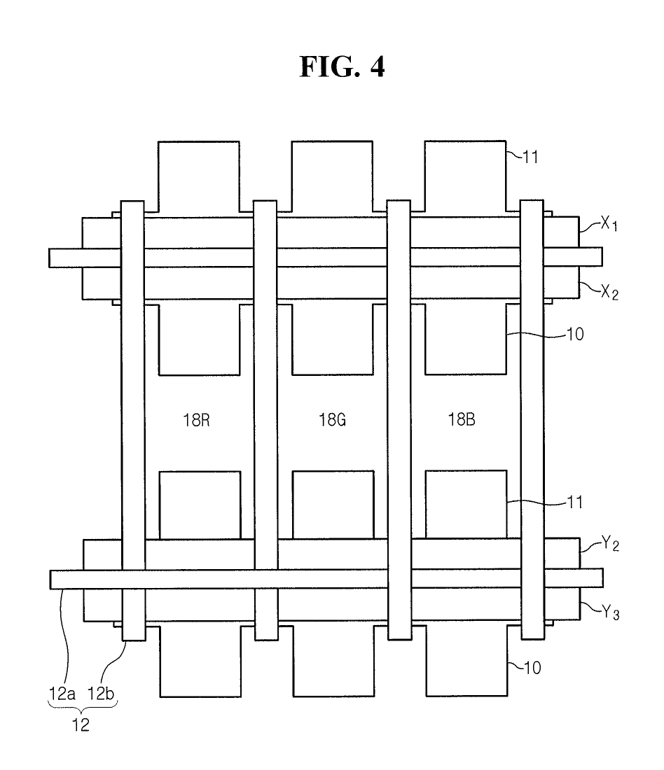

Examples of closed barrier rib configurations will be described with reference to FIG. 4 to FIG. 6.

FIG. 4 shows a diagram of a closed barrier rib configuration of a PDP according to a first exemplary embodiment of the present invention, the PDP having an XXYY arrangement configuration.

As shown in FIG. 4, the barrier ribs 12 include a first barrier rib 12a formed in a row direction and a second barrier rib 12b formed in a column direction. Here, the first barrier rib 12a is formed to partition the discharge cells neighboring in the column direction, and the second barrier rib 12b is formed to partition the discharge cells neighboring in the row direction.

In one embodiment, discharge cells 18R, 18G, and 18B are partitioned from other discharge cells by corresponding first barrier ribs 12a and corresponding second barrier ribs 12b. Phosphor layers for emitting visible light for each color are respectively formed in the discharge cells partitioned by the barrier ribs. The discharge cells are classified as red discharge cells 18R, green discharge cells 18G, and blue discharge cells 18B according to the color of the phosphor layer. A combined discharge gas including neon and xenon is provided in the discharge cells 18R, 18G, and 18B including the phosphor layers.

In addition, according to the XXYY arrangement configuration, the pairs of X electrodes (e.g., X1 and X2) or the pairs of Y electrodes (e.g., Y2 and Y3) are arranged on one first barrier rib 12a. Accordingly, the arranged X and Y electrodes are formed by combinations of a bus electrode and transparent electrodes 10 and 11. Here, the transparent electrodes 10 and 11 of the X and Y electrodes protrude to face each other.

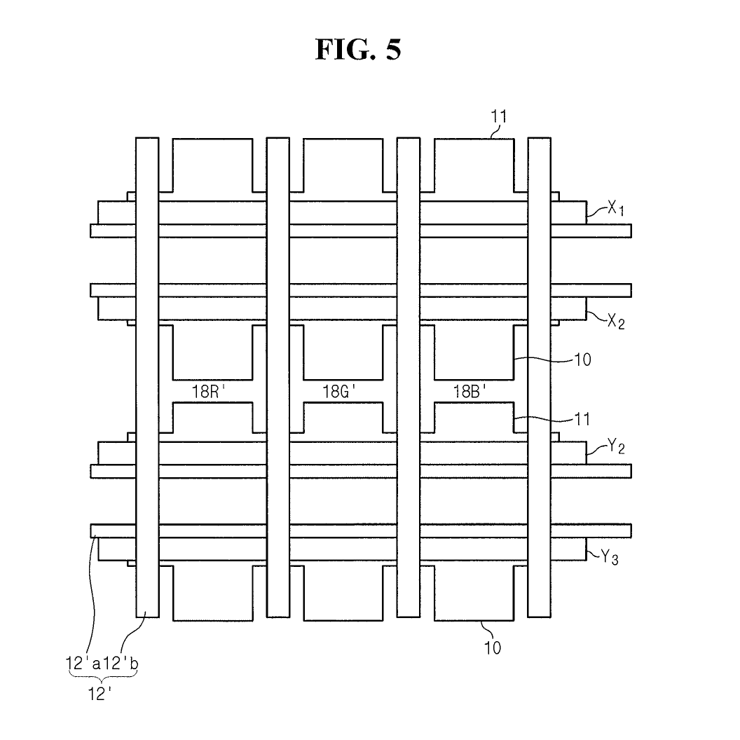

Another example of a closed barrier rib configuration will now be described with reference to FIG. 5. FIG. 5 shows a diagram of a closed barrier rib configuration of a PDP according to a second exemplary embodiment of the present invention.

As shown in FIG. 5, barrier ribs 12′ include a first barrier rib 12a′ formed in a row direction and a second barrier rib 12b′ formed in a column direction. Here, pairs of first barrier ribs 12a′ are formed so that the first barrier ribs 12a′ may not be shared by the discharge cells neighboring in a column direction, and a channel is formed to separate two adjacent first barrier ribs 12a′.

Accordingly, two of the first barrier ribs 12a′ partition the discharge cells neighboring in a column direction, and one of the second barrier ribs 12b′ partitions the discharge cells neighboring in a row direction. Therefore, the respective discharge cells 18R′, 18G′, and 18B′ are partitioned from other discharge cells by the first barrier ribs 12a′ and the second barrier ribs 12b′.

As described, in one embodiment, the phosphor layers for each color are respectively formed in the discharge cells partitioned by the barrier ribs. The discharge cells are classified as red discharge cells 18R′, green discharge cells 18G′, and blue discharge cells 18B′ according to the color of the phosphor layer. The combined discharge gas including neon and xenon is provided in the discharge cells 18R′, 18G′, and 18B′ including the phosphor layer.

In addition, according to the XXYY arrangement configuration (see, for example, FIG. 5), two neighboring X electrodes (e.g., X1 and X2) and two neighboring Y electrodes (e.g., Y2 and Y3) are respectively arranged on pairs of the first barrier ribs 12a′. The arranged X and Y electrodes are formed by combinations of a bus electrode and transparent electrodes 10 and 11. Here, the transparent electrodes 10 and 11 of the X and Y electrodes protrude to face each other.

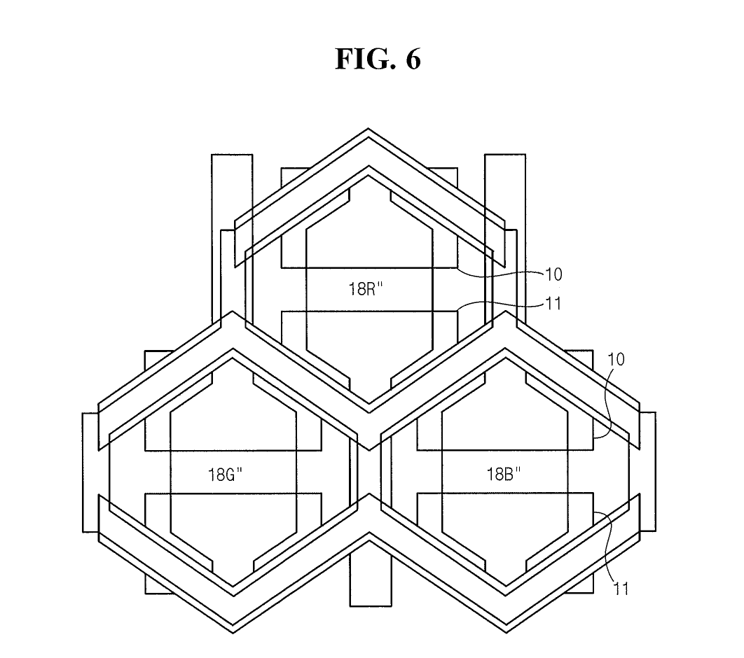

A third example of a closed barrier rib configuration will be described with reference to FIG. 6. FIG. 6 shows a configuration of the closed barrier rib according to a third exemplary embodiment of the present invention.

The closed barrier rib configuration shown in FIG. 6 includes a hexagonal discharge cell, differing from those of FIG. 4 and FIG. 5. That is, the barrier ribs include six barrier ribs extending in six respective directions. The barrier ribs are formed to partition neighboring discharge cells (i.e., by the barrier ribs extending in the respective directions).

The respective discharge cells 18R″, 18G″, and 18B″ are partitioned from neighboring discharge cells by the six barrier ribs, which are connected in a closed loop.

As described, in one embodiment, the phosphor layers for each color are respectively formed in the discharge cells partitioned by the barrier ribs. The discharge cells are classified as red discharge cells 18R″, green discharge cells 18G″, and blue discharge cells 18B″ according to the color of the phosphor layer. The combined discharge gas including neon and xenon is provided in the discharge cells 18R″, 18G″, and 18B″ including the phosphor layer.

As such, with respect to the six barrier ribs forming one discharge cell, the X and Y electrodes are arranged on the four barrier rib members generally extending in a row direction.

The X and Y electrodes are formed by combinations of a bus electrode and transparent electrodes 10 and 11. Here, the transparent electrodes 10 and 11 of the X and Y electrodes protrude to face each other.

Compared to a stripe barrier rib configuration, in discharge cells of a closed barrier rib configuration, a plasma discharge is generated in a relatively limited area partitioned by the barrier ribs, and an area of the phosphor layer is wider in the discharge cells.

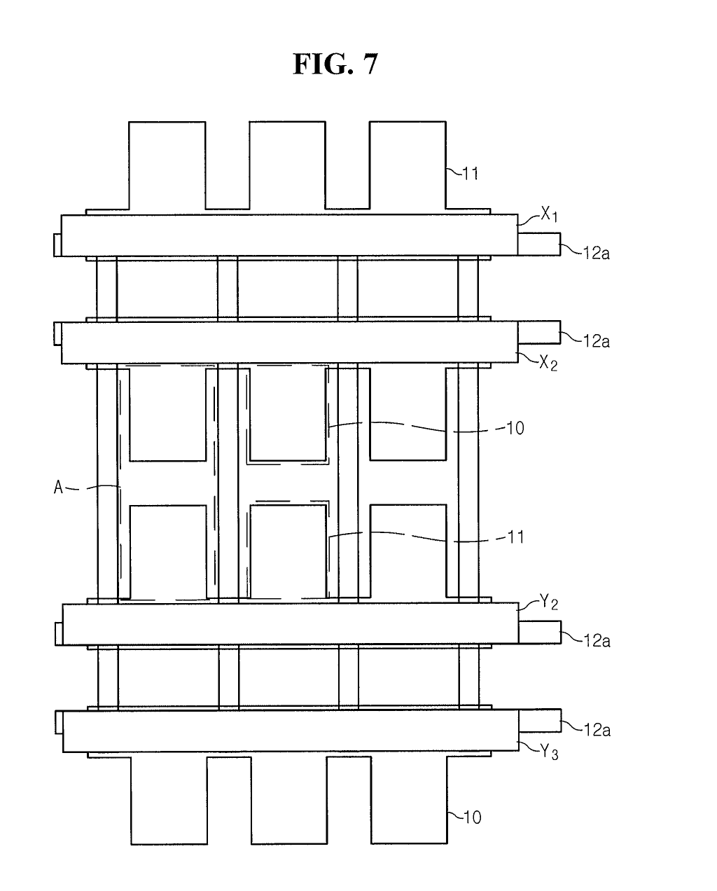

An area of the sustain and scan electrodes (i.e., a discharge area) in discharge cells of a PDP without (i.e., not having) an alignment error will be described with reference to FIG. 7. FIG. 7 shows a diagram representing the portions of the sustain and scan electrodes of the PDP without the alignment error.

As shown in FIG. 7, there is no alignment error when the bus electrodes of the X and Y electrodes are formed to correspond to the first barrier ribs extending in a row direction.

When there is no alignment error, a space A partitioned by barrier ribs in a row direction and barrier ribs in a column direction is used as a discharge space. Here, areas of the transparent electrode 10 of the X electrode and the transparent electrode 11 of the Y electrode that occupy the discharge space (hereinafter referred to as “first areas”) are respectively equal in size to areas of the transparent electrodes 10 and 11 themselves (hereinafter referred to as “second areas”). That is, when there is no alignment error, the first areas of the Y electrodes for respective discharge cells are the same (i.e., they are equal in size).

Accordingly, the same amount of light is generated by the X and Y electrodes of the respective discharge cells when driving waveforms alternately having two respective voltages are applied during the sustain period of one subfield in a PDP having no alignment error. Accordingly, since the same luminance (or brightness) is generated between neighboring discharge cells, image streaking is not generated.

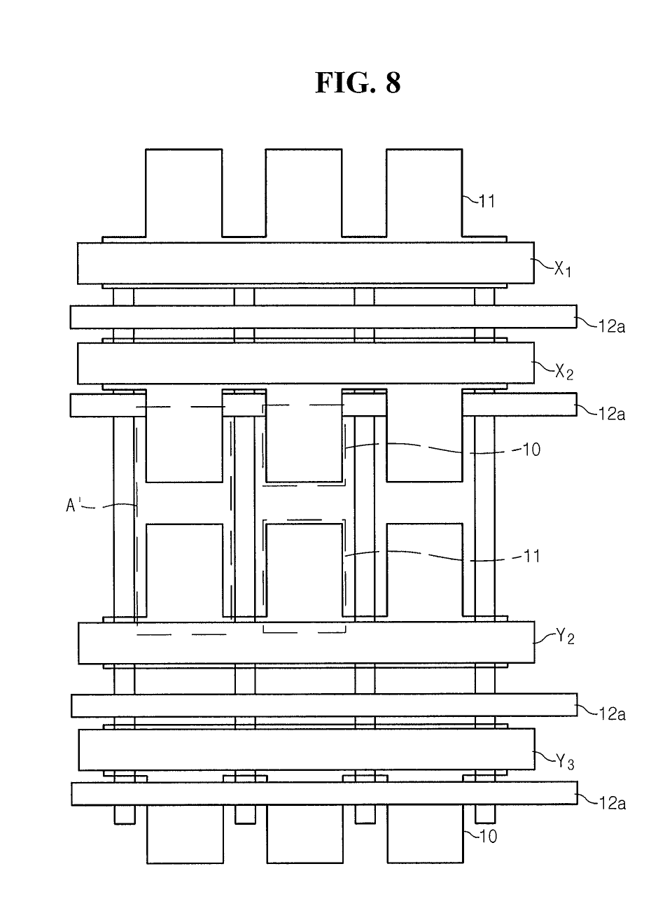

Areas of sustain and scan electrodes in discharge cells of a PDP having an alignment error will be described with reference to FIG. 8. FIG. 8 shows a diagram representing areas of sustain and scan electrodes in a PDP having an alignment error.

As shown in FIG. 8, the alignment error is generated when the bus electrodes of the X and Y electrodes are formed to be misaligned with the first barrier ribs extending in a row direction.

When the alignment error is generated, a column side length of the discharge space of each discharge cell is reduced by the amount of the alignment error (i.e., a distance between the barrier rib in the row direction and the X electrode (or the Y electrode)). Accordingly, a space A′ smaller than the discharge space A and partitioned by the barrier ribs is used as a discharge space in the respective discharge cells. Here, one of the first areas of the transparent electrode 10 of the X electrode and the transparent electrode 11 of the Y electrode corresponds to the second area, but the other of the first areas is smaller than the second area.

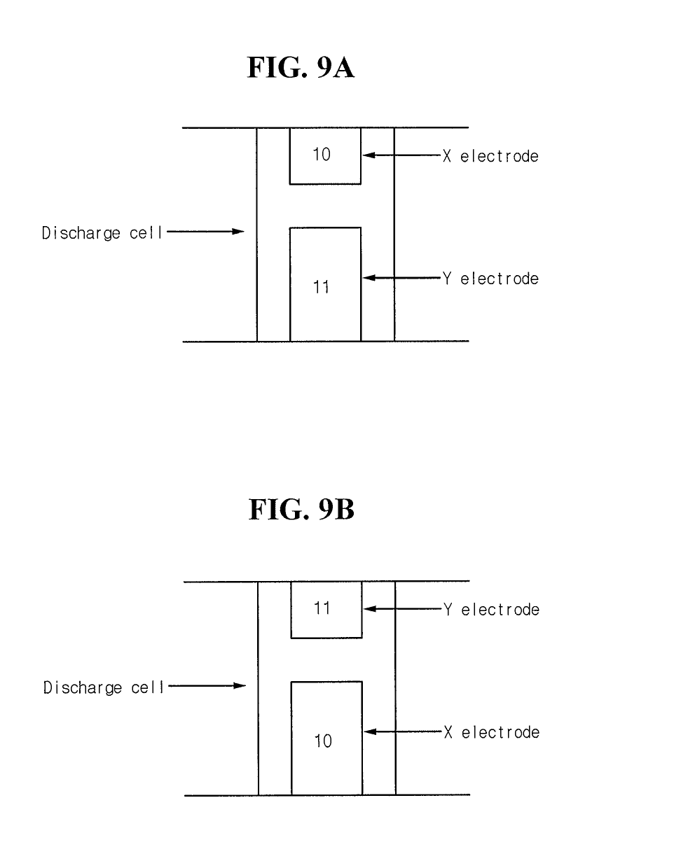

Accordingly, when the alignment error is generated, as shown in FIG. 8 and FIG. 9A, the first area of the transparent electrode 10 of the X electrode is smaller than the second area thereof in a first discharge cell, and the first area of the transparent electrode 11 of the Y electrode corresponds to the second area thereof. In addition, as shown in FIG. 9B, in a second discharge cell neighboring the first discharge cell in a column direction, the first area of the transparent electrode 10 of the X electrode corresponds to the second area thereof, and the first area of the transparent electrode 11 of the Y electrode is smaller than the second area thereof.

In addition, the same driving waveforms but having different phases are applied to the X and Y electrodes during the sustain period. That is, the controller 200 controls the scan and sustain electrode drivers to apply the same driving waveforms to the X and Y electrodes.

However, the driving waveforms actually applied to the X and Y electrodes may be different since there is an impedance difference between driving circuits of the scan and sustain electrode drivers 400 and 500.

The driving waveform generated by the driving circuit of the sustain electrode driver 500 is generated and directly applied to the X electrodes, but the driving waveform generated by the driving circuit of the scan electrode driver 400 is generated, transmitted to a plurality of transistors and a scan integrated circuit (IC), and applied to the Y electrodes. Accordingly, the driving circuit of the scan electrode driver 400 has a parasitic impedance caused by switching operations of the transistors and a parasitic impedance caused by a complicated printed circuit board (PCB) pattern. That is, the driving circuit of the scan electrode driver 400 has higher impedance than the driving circuit of the sustain electrode driver 500.

The impedance of the respective driving circuits affects the driving waveforms, and therefore the luminance (or brightness) of the discharge cells according to the X electrode driving waveform and the luminance of the discharge cells according to the Y electrode driving waveform may be different. For example, the X electrode driving waveform produces a relatively high luminance in accordance with each sustain pulse since the lower impedance of the driving circuit of the sustain electrode driver 500 causes a relatively low distortion of the X electrode driving waveform. The Y electrode driving waveform produces a relatively low luminance in accordance with each sustain pulse since the higher impedance of the driving circuit of the scan electrode driver 400 causes a relatively high distortion of the Y electrode driving waveform.

Generally, the light emission of the discharge cell is directly proportional to the area of the transparent electrode. That is, the luminance greatly varies with a variation of the area of the transparent electrode at which a relatively high luminance is produced with each sustain pulse, and the luminance varies slightly with a variation of the area of the transparent electrode at which a relatively low luminance is produced with each sustain pulse.

Accordingly, in the respective neighboring discharge cells of a PDP having the closed rib configuration and the different electrode arrangement configurations, discharge characteristics between the X and Y electrodes may vary according to the sizes of the first areas and the discharge space. That is, differences in the discharge characteristics are shown between the even and odd lines. Therefore, image streaking is generated between the even and odd lines.

However, the luminance for each sustain pulse is not always high when the impedance of the X electrodes (i.e., the impedance of the driving circuit of the sustain electrode driver 500) is lower than that of the Y electrodes (i.e., the impedance of the driving circuit of the scan electrode driver 400) because the driving waveform may be differently distorted due to switching timing for generating the driving waveform in the transistors and impedance matching, and, as such, the luminance corresponding to each sustain pulse may vary. Accordingly, even when the impedance of the Y electrodes is higher than that of the X electrodes, the luminance of the X electrode may be brighter or darker than that of the Y electrode.

A method for solving an image streaking problem generated between the odd and even lines will now be described with reference to FIGS. 9A and 9B and FIG. 10.

FIGS. 9A and 9B show an electrode configuration diagram of two neighboring discharge cells in a PDP having an alignment error. In further detail, FIG. 9A shows a discharge cell configuration of an odd line, and FIG. 9B shows a discharge cell configuration of an even line. Hereinafter, the discharge cell of the odd line shown in FIG. 9A will be referred to as an A type of discharge cell, and the discharge cell of the even line shown in FIG. 9B will be referred to as a B type of discharge cell.

The first area of the transparent electrode 10 of the X electrode is smaller than that of the transparent electrode 11 of the Y electrode in the A type of discharge cell. The first area of the transparent electrode 10 of the X electrode is greater than that of the transparent electrode 11 of the Y electrode in the B type of discharge cell.

A driving method according to an exemplary embodiment of the present invention will be described with reference to FIG.10.

However, for better understanding and ease of description, discharge characteristics (i.e., the luminescence characteristics) in the A and B types of discharge cells in a normal state, in which the same driving waveforms are applied to the X and Y electrodes during the sustain period, will be described first.

In the A type of discharge cell, a first luminance is produced when the sustain pulse is applied to the X electrode, and a second luminance is produced when the sustain pulse is applied to the Y electrode. Here, even when the X electrode luminance for each sustain pulse is greater than that of the Y electrode, since the first area of the Y electrode is greater than that of the X electrode, the second luminance is greater than the first luminance.

In the B type of discharge cell, a third luminance is produced when the sustain pulse is applied to the Y electrode, and a fourth luminance is produced when the sustain pulse is applied to the X electrode. Here, since the X electrode luminance for each sustain pulse is greater than that of the Y electrode and the first area of the X electrode is greater than that of the Y electrode, the fourth luminance is greater than the third luminance.

The fourth luminance produced by applying the sustain pulse to the X electrode in the B type of discharge cell, in which the first area of the X electrode is larger than that of the Y electrode, is higher than the first to third luminances, and the third luminance produced by applying the sustain pulse to the Y electrode in the B type of discharge cell, in which the first area of the Y electrode is smaller than the second area of the X electrode, is less than the first, second, and fourth luminances. That is, the fourth luminance is greater than the second luminance, the second luminance is greater than the first luminance, and the first luminance is greater than the third luminance.

Accordingly, the discharge characteristics of the X and Y electrodes are different between the A and B types of discharge cells, and the image streaking is generated between the odd and even lines.

A driving method for solving (or reducing) the image streaking will be described with reference to FIG. 10.

FIG. 10 shows driving waveforms applied to the scan and sustain electrodes during the sustain period in a driving method of a plasma display device according to an exemplary embodiment of the present invention. In FIG. 10, the X electrode luminance for each sustain pulse is greater than the Y electrode luminance for each sustain pulse.

When an alignment error is generated between the X and Y electrodes in a PDP, the controller 200 outputs the sustain and scan electrode driving control signals for compensating the image streaking. Accordingly, the scan electrode driver 400 and the sustain electrode driver 500 respectively output the driving waveforms shown in FIG. 10 during the sustain period.

As shown in FIG. 10, sustain pulses alternately having low and high level voltages are applied to the X and Y electrodes during the sustain period.

Here, the high level voltage of the sustain pulses applied to the X electrodes is the same as that of the sustain pulses applied to the Y electrodes, and the low level voltage of the sustain pulses applied to the X electrodes is the same as that of the sustain pulse applied to the Y electrodes.

However, a duration period (hereinafter referred to as a “high level duration period”) L1 for maintaining the high level voltage of the sustain pulse applied to the X electrodes is different from a high level duration period L2 of the sustain pulse applied to the Y electrodes. In addition, a high level period L3 of the sustain pulse applied to the X electrodes is different from a high level period L4 of the sustain pulse applied to the Y electrodes. Here, the high level duration period is obtained by subtracting a duration period for maintaining the low level voltage from one period (or cycle) of the sustain pulse waveform. For example, the high level period includes a period during which the waveform increases from the low level voltage to the high level voltage, the high level duration period, and a period during which the waveform decreases from the high level to the low level.

In further detail, the high level duration period L1 of the sustain pulse applied to the X electrodes is shorter than a high level duration period of a normal sustain pulse, and the high level duration period L2 of the sustain pulse applied to the Y electrodes is longer than the high level duration period of the normal sustain pulse. The high level period L3 of the sustain pulse applied to the X electrodes is shorter than a high level period of the normal sustain pulse, and the high level period L4 of the sustain pulse applied to the Y electrodes is longer than the high level period of the normal sustain pulse. Here, the above-mentioned normal sustain pulse is a sustain pulse applied to the X and Y electrodes of a PDP having no alignment error.

Variations of the high level period and the high level duration period in relation to the normal sustain pulse are in direct proportion to the alignment error values (e.g., the magnitude of the alignment error). For example, the variation of the high level period and the high level duration period is set low relative to the normal sustain pulse when an alignment error of a PDP is low (or small), and the variation of the high level period and the high level duration period is set high when an alignment error of a PDP is great (or high).

Accordingly, in one embodiment, the high level duration period L1 is shorter than the high level duration period L2, and the high level period L3 is shorter than the high level period L4.

The luminescence characteristics formed when the X and Y electrode driving waveforms, as described above, are applied to the A and B types of discharge cells shown in FIGS. 9A and 9B will be described in more detail.

When the X electrode sustain pulse having the reduced (or shortened) high level duration period L1 and the high level period L3 is applied to the A type of discharge cell, a fifth luminance that is lower than the first luminance is produced in the A type of discharge cell since a discharge time is reduced.

When the Y electrode sustain pulse having the increased (or lengthened) high level duration period L2 and the high level period L4 is applied to the A type of discharge cell, a sixth luminance that is higher than the second luminance is produced since the discharge time is increased. When the X electrode sustain pulse having the reduced high level duration period L1 and the high level period L3 is applied to the B type of discharge cell, a seventh luminance that is lower than the third luminance is produced in the B type of discharge cell since the discharge time is reduced.

When the Y electrode sustain pulse having the increased high level duration period L2 and the high level period L4 is applied to the B type of discharge cell, an eighth luminance that is higher than the fourth luminance is produced since the discharge time is increased.

As previously described, the fourth luminance is greater than the second luminance, the second luminance is greater than the first luminance, and the first luminance is greater than the third luminance.

Here, in accordance with the driving waveforms shown in FIG. 10, the eighth luminance, which is increased from the fourth luminance, is produced at the B type of discharge cell, and the sixth luminance, which is increased from the second luminance, is produced at the A type of discharge cell. Accordingly, a difference between the eighth luminance and the sixth luminance is reduced to be less than or equal to a difference between the fourth luminance and the second luminance.

In addition, in accordance with the driving waveforms shown in FIG. 10, the seventh luminance, which is decreased from the third luminance, is produced at the B type of discharge cell, and the fifth luminance, which is decreased from the first luminance is produced at the A type of discharge cell. Accordingly, a difference between the seventh luminance and the fifth luminance is reduced to be less than or equal to a difference between the first luminance and the third luminance.

In the respective discharge cells, a sum of the fifth and sixth luminances is formed in the A type of discharge cell, and a sum of the seventh and eighth luminances is formed in the B type of discharge cell.

As such, the luminance generated in the A type of discharge cell is substantially equal to that generated in the B type of discharge cell, and the problem of the image streaking between the even and odd lines is solved (or reduced).

In addition, in contrast to the above-described embodiment of the present invention, the luminance of the Y electrode for each sustain pulse may be greater than the luminance of the X electrode for each sustain pulse. Here, the driving waveforms shown in FIG. 10 are switched and applied to the electrodes, according to an alternative exemplary embodiment of the present invention. That is, according to the alternative exemplary embodiment of the present invention, the high level duration period and the high level period of the sustain pulses applied to the X electrodes are increased to be longer than that of the normal sustain pulse, and the high level duration period and the high level period of the sustain pulses applied to the Y electrodes are reduced to be shorter than that of the normal sustain pulse.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to exemplary embodiments of the present invention, in a PDP in which image streaking may normally be generated between even and odd lines due to an alignment error of the X and Y electrodes, since voltage applying periods and voltage duration periods of the sustain pulse of the X and Y electrodes are set to be different from each other, the problem of the image streaking is solved (or reduced).

What is claimed is:

1. A method for driving a plasma display device during an address period of a subfield, the plasma display device comprising a plasma display panel (PDP) having different electrode arrangement configurations between discharge cells of the PDP neighboring in a column direction, the PDP comprising a plurality of first electrodes and a plurality of second electrodes, a plurality of third electrodes crossing the first and second electrodes, the discharge cells formed at crossing regions of the first, second, and third electrodes, and a plurality of barrier ribs, each of the discharge cells being individually surrounded by the barrier ribs, the PDP having an alignment error between the first and second electrodes and the barrier ribs, the method comprising:
applying a first sustain pulse having a high level duration period longer than a first period to the first electrodes; and
applying a second sustain pulse having a high level duration period shorter than the first period to the second electrodes,
wherein the first and second sustain pulses alternately have a high level and a low level and the first and second sustain pulses have opposite phases with respect to each other.

2. The method of claim 1, wherein the first period corresponds to a high level duration period of a sustain pulse applied to the first and second electrodes of the PDP when the PDP has substantially no alignment error.

3. The method of claim 2, wherein a high level period of the first sustain pulse has a duration different from a duration of a high level period of the second sustain pulse.

4. The method of claim 2, wherein a high level period of the first sustain pulse has a duration longer than a duration of a high level period of the second sustain pulse.

5. The method of claim 4, wherein the first sustain pulse produces a discharge characteristic lower than that of the second sustain pulse when a duration of the high level duration period of the first sustain pulse is substantially equal to a duration of the high level duration period of the second sustain pulse and a duration of the high level period of the first sustain pulse is substantially equal to a duration of the high level period of the second sustain pulse.

6. The method of claim 2, wherein the first sustain pulse has a high level period longer than a second period, the second sustain pulse has a high level period shorter than the second period, and the second period corresponds to a high level period of a sustain pulse applied to the first and second electrodes of the PDP when the PDP has substantially no alignment error.

7. The method of claim 2, wherein the first sustain pulse has a discharge characteristic lower than that of the second sustain pulse when a duration of the high level duration period of the first sustain pulse and a duration of the high level duration period of the second sustain pulse are substantially equal to each other.

8. The method of claim 7, wherein a luminance deviation is not substantially generated between a sum of a first luminance produced in accordance with the first sustain pulse and a second luminance produced in accordance with the second sustain pulse at a first discharge cell of the discharge cells and a sum of a third luminance produced in accordance with the first sustain pulse and a fourth luminance produced in accordance with the second sustain pulse at a second discharge cell of the discharge cells, the second discharge cell neighboring the first discharge cell in the column direction.

9. A plasma display device adapted to be driven during frames, the plasma display device comprising:
a plasma display panel (PDP) having different electrode arrangement configurations between discharge cells of the PDP neighboring in a column direction, the PDP comprising a plurality of first electrodes and a plurality of second electrodes, a plurality of third electrodes crossing the first and second electrodes, the discharge cells formed at crossing regions of the first, second, and third electrodes, and a plurality of barrier ribs, each of the discharge cells being individually surrounded by the barrier ribs;
a controller for dividing each of the frames into a plurality of subfields, each of the subfields including a reset period, an address period, and a sustain period, and for driving the subfields;
a first electrode driver for generating a first sustain pulse according to a control operation of the controller and applying the first sustain pulse to the plurality of first electrodes; and
a second electrode driver for generating a second sustain pulse according to the control operation of the controller and applying the second sustain pulse to the plurality of second electrodes,
wherein the first sustain pulse has a high level duration period longer than a first period and the second sustain pulse has a high level duration period shorter than the first period, and
wherein the first and second electrode drivers are adapted to alternately apply the first and second sustain pulses to the first and second electrodes, respectively, the first and second sustain pulses having opposite phases with respect to each other.

10. The plasma display device of claim 9, wherein the first period corresponds to a high level duration period of a sustain pulse applied to the first and second electrodes of the PDP when the PDP has substantially no alignment error.

11. The plasma display device of claim 10, wherein a high level period of the first sustain pulse has a duration different from a duration of a high level period of the second sustain pulse.

12. The plasma display device of claim 1 1, wherein the high level period of the first sustain pulse is longer than the high level period of the second sustain pulse.

13. The plasma display device of claim 10, wherein the first sustain pulse produces a discharge characteristic lower than that of the second sustain pulse when a duration of the high level duration period of the first sustain pulse and a duration of the high level duration period of the second sustain pulse are substantially equal to each other.

14. The plasma display device of claim 10, wherein the first sustain pulse has a high level period longer than a second period, the second sustain pulse has a high level period shorter than the second period, and the second period corresponds to a high level period of a sustain pulse applied to the first and second electrodes of the PDP when the PDP has substantially no alignment error.

15. The plasma display device of claim 14, wherein the first sustain pulse has a discharge characteristic lower than that of the second sustain pulse when a duration of the high level duration period of the first sustain pulse is substantially equal to a duration of the high level duration period of the second sustain pulse and a duration of the high level period of the first sustain pulse is substantially equal to a duration of the high level period of the second sustain pulse.

16. The plasma display device of claim 15, wherein a luminance deviation is not substantially generated between a sum of a first luminance produced in accordance with the first sustain pulse and a second luminance produced in accordance with the second sustain pulse at a first discharge cell of the discharge cells and a sum of a third luminance produced in accordance with the first sustain pulse and a fourth luminance produced in accordance with the second sustain pulse at a second discharge cell of the discharge cells, the second discharge cell neighboring the first discharge cell in the column direction.

17. A method for driving a plasma display device, the plasma display device comprising a plasma display panel (PDP) comprising a plurality of first electrodes, a plurality of second electrodes, and a plurality of barrier ribs, discharge cells of the PDP each being individually surrounded by the barrier ribs, the PDP having a misalignment between the barrier ribs and the first and second electrodes, the method comprising:
applying a first high level sustain pulse to the first electrodes during a first period; and
applying a second high level sustain pulse to the second electrodes during a second period, the second period preceding the first period and being shorter than the first period.
